(19) United States
(12) Patent Application Publication
(10) Pub. No.: US 2016/0301673 A1
(43) Pub. Date: Oct. 13, 2016

(54) Method for Realizing Secure Communications among Machine Type Communication Devices and Network Entity

(71) Applicant: ZTE CORPORATION, Shenzhen, Guangdong (CN)

(72) Inventor: Wantao YU, Shenzhen City, Guangdong Province (CN)

(73) Assignee: ZTE Corporation

(21) Appl. No.: 15/031,515

(22) PCT Filed: May 5, 2014
(86) PCT No.: PCT/CN2014/076774

§ 371 Date: May 25, 2016

(30) Foreign Application Priority Data
Oct. 25, 2013 (CN) 201310512463.1

(51) Int. Cl. H04L 29/06; H04W 12/04; H04W 4/00; G06F 21/60

(52) U.S. Cl. CPC H04L 63/065; G06F 21/606; H04W 12/04; H04W 4/005

(57) ABSTRACT

A method for realizing secure communication between machine type communication devices and a network entity, the method includes: creating, by a network entity, an MTC device group for a directly-communicating MTC device, and saving MTC device group information corresponding to the MTC device group and MTC device information of an MTC devices contained in the MTC device group, herein the MTC device group information includes MTC device group identification information and MTC device group key information; and sending, by the network entity, the MTC device group information of the MTC device group, to which the MTC device belongs, to the MTC device.

### CROSS-REFERENCE TO RELATED APPLICATION(S)

This application is the U.S. National Phase application of PCT application number PCT/CN2014/076774 having a PCT filing date of May 5, 2014, which claims priority of Chinese patent application 201310512463.1 filed on Oct. 25, 2013, the disclosures of which are hereby incorporated by reference.

### TECHNICAL FIELD

The present invention relates to the technical field of communication, in particular to a method for realizing secure communication between machine type communication devices and a network entity.

### BACKGROUND OF RELATED ART

Machine type communication (referred to as simply MTC) refers to a general name of a series of technologies and combinations thereof for realizing data communication and exchange of machine to machine and machine to man by applying a wireless communication technology. MTC contains two layers of meanings, herein the first layer of meaning is the machine itself, it is called as a smart device in the embedded field; and the second layer of meaning is the connection of machine to machine, the machines are connected together through a network. Machine type communication is applied in a very wide range such as smart measurement and remote monitoring etc., so as to enable human life to be more intelligent. Compared with traditional communication between man and man, MTC devices are huge in number, are used widely in application field and have a huge market prospect.

In the current 3rd Generation Partnership Project(3GPP) LTE (Long Term Evolution) and LTE-A (LTE Advanced) wireless communication network, D2D (Device to Device) direct communication is such a communication mode, herein subscriber devices perform direct Peer to Peer (P2P) communication by sharing/reusing wireless link (uplink or downlink) resources of the wireless communication network. In the current cellular mobile communication network based on infrastructures, a base station (BS, NB or eNB) is used as a central control node and is a unique access point for obtaining network service by mobile devices. All mobile devices can communicate with some certain base station in the network only through uplink or downlink channels in cellular systems. However, when multiple mobile devices get close to one another, if D2D direct communication between the mobile devices is supported, many benefits will be brought to the traditional cellular communication. These benefits include: a longer time for using device battery, a higher wireless resource use efficiency, a wider signal coverage range, a lower system interference level and the like. In the cellular networks which are enhanced by using the D2D technology, on one hand, the direct communication between the mobile devices can benefit from the centralized control structures of the cellular networks; and on the other hand, by utilizing high-quality D2D links (direct links from device to device), the transmission efficiency of the traditional cellular networks can be greatly improved. For an MTC system, communication between MTC devices which get close to one another through the D2D mode will decrease the network load caused by MTC communication.

In the MTC system, the MTC devices can communicate with other MTC servers or MTC devices through a 3GPP network. When the MTC devices communicate through the 3GPP network, a session connection needs to be established between the MTC device and the MTC server or between the MTC device and the MTC device. From the perspective of protocols, the session connection between the MTC device and the MTC server or other MTC device belongs to a function of an application layer. For the communication between the MTC device and the MTC server, the session connection can be established through a related mobile communication process to realize information exchange between the MTC device and the MTC server. The communication between the MTC devices can be direct data communication on the application layer, as below shown in FIG. 1.

The communication between the MTC devices can also be indirect data communication on the application layer through the MTC server, as below shown in FIG. 2.

### SUMMARY OF THE INVENTION

In view of the situations of communication between MTC (Machine Type Communication) devices, in order to guarantee the security of communication between the MTC devices, a shared key is needed to be established between the communicating MTC devices to realize security control and management of communication between the MTC devices. In view of the situations of communication between the MTC devices, how to establish the shared key between the communicating MTC devices is a technical problem which needs to be urgently solved.

The present invention provides a method for realizing secure communication between machine type communication devices and a network entity, so as to guarantee the security problem of data communication between the MTC devices.

A method for realizing secure communication between machine type communication (MTC) devices provided by the present invention includes:

creating, by a network entity, an MTC device group for a directly-communicating MTC device, and saving MTC device group information corresponding to the MTC device group and MTC device information of an MTC device contained in the MTC device group, herein the MTC device group information includes MTC device group identification information and MTC device group key information; and

sending, by the network entity, the MTC device group information of the MTC device group, to which the MTC device belongs, to the MTC device.

Optionally, the network entity is a Home Subscriber Server (HSS), and creating, by the HSS, an MTC device group for a directly-communicating MTC device under any one of the following situations includes:

creating the MTC device group for an MTC device which needs to directly communicate according to a creating request of an MTC subscriber;

creating the MTC device group for an MTC device which needs to directly communicate under a situation that a direct communication request initiated by the MTC device is received; and

creating the MTC device group for an MTC device which needs to directly communicate according to a request of an entity which manages communication between MTC devices.

Optionally, the network entity is an entity which manages communication between MTC devices, and creating, by the entity which manages communication between MTC devices, an MTC device group for a directly communicating MTC device under any one of the following situations includes:

creating, by the entity which manages communication between MTC devices, the MTC device group for an MTC device which needs to directly communicate under a situation that the entity which manages communication between MTC devices receives the direct communication request initiated by the MTC device; and

creating, by the entity which manages communication between MTC devices, the MTC device group for an MTC device which needs to directly communicate when the entity which manages communication between MTC devices establishes a direct communication between MTC devices.

Optionally, the entity which manages communication between MTC devices is a base station, a Mobility Management Entity (MME) or a Service GPRS Supporting Node (SGSN).

Optionally, sending, by the network entity, the MTC device group information of the MTC device group, to which the MTC device belongs, to the MTC device includes:

when the network entity creates the MTC device group for the MTC device which needs to directly communicate under the situation that the network entity receives the direct communication request initiated by the MTC device, after creating the MTC device group, sending the MTC device group information to the MTC device which initiates the direct communication request.

Optionally, sending, by the network entity, the MTC device group information of the MTC device group, to which the MTC device belongs, to the MTC device further includes:

when there is an MTC device initially attaching, checking, by the network entity, the MTC device group information of the MTC device according to MTC device information, and when the MTC device belongs to the created MTC device group, after the MTC device completes the attachment, sending the MTC device group information of the MTC device to the MTC device in a secure way.

Optionally, sending, by the network entity, the MTC device group information of the MTC device group, to which the MTC device belongs, to the MTC device includes:

after the network entity creates the MTC device group, sending, by the network entity, the MTC device group information to all MTC devices contained in the MTC device group.

Optionally, the method further includes:

generating, by the network entity, an encryption key and an integrity protection key according to the MTC device group key information;

wherein the MTC device group information includes MTC device group identification information, MTC device group key information, encryption key information and integrity protection key information.

Optionally, a method for realizing secure communication between machine type communication (MTC) devices includes:

receiving, by an MTC device, MTC device group information corresponding to an MTC device group, to which the MTC device belongs, from a network entity, herein the MTC device group information includes MTC device group identification information and MTC device group key information; and

using, by the MTC device, the MTC device group key information as a shared key with different MTC devices in the MTC device group, to which the MTC device belongs, for protecting secure communication with different MTC devices in the MTC device group to which the MTC device belongs.

Optionally, the method further includes the following steps:

generating, by the MTC device, an encryption key and an integrity protection key for protecting secure data transmission between MTC devices according to the MTC device group key information; and

performing, by the MTC device, secure MTC data transmission with different MTC devices in the MTC device group, to which the MTC device belongs, through the encryption key and the integrity protection key.

Optionally, the method further includes:

the MTC device group information further including an encryption key and an integrity protection key; and

performing, by the MTC device, secure MTC data transmission with different MTC devices in the MTC device group, to which the MTC device belongs, through the encryption key and the integrity protection key.

Optionally, a network entity includes a group creating unit and a sending unit, herein:

the group creating unit is configured to create an MTC device group for a directly-communicating MTC device, and save MTC device group information corresponding to the MTC device group and MTC device information of an MTC device contained in the MTC device group, herein the MTC device group information includes MTC device group identification information and MTC device group key information; and

the sending unit is configured to send the MTC device group information of the MTC device group, to which the MTC device belongs, to the MTC device.

Optionally, the group creating unit is set at a Home Subscriber Server (HSS), and the group creating unit creates an MTC device group for a directly-communicating MTC device in any one of the following ways:

the group creating unit creates the MTC device group for an MTC device which needs to directly communicate according to a creating request of an MTC subscriber;

the group creating unit creates the MTC device group for an MTC device which needs to directly communicate under a situation that a direct communication request initiated by the MTC device is received; and

the group creating unit creates the MTC device group for an MTC device which needs to directly communicate according to a request of an entity which manages communication between MTC devices.

Optionally, the group creating unit is set at an entity which manages communication between MTC devices, and the group creating unit creates an MTC device group for a directly-communicating MTC device in any one of the following ways:

the group creating unit creates the MTC device group for an MTC device which needs to directly communicate under a situation that the entity which manages communication between MTC devices receives a direct communication request initiated by the MTC device; and

the group creating unit creates the MTC device group for an MTC device which needs to directly communicate when the entity which manages communication between MTC devices establishes a direct communication between MTC devices.

Optionally, the entity which manages communication between MTC devices is a base station, a Mobility Management Entity (MME) or a Service GPRS Supporting Node (SGSN).

Optionally, the sending unit sends the MTC device group information of the MTC device group, to which the MTC device belongs, to the MTC device in the following way:

when the group creating unit creates the MTC device group for the MTC device which needs to directly communicate under the situation that the group creating unit receives the direct communication request initiated by the MTC device, after the group creating unit creates the MTC device group, the sending unit sends the MTC device group information to the MTC device which initiates the direct communication request.

Optionally, the sending unit is further configured to, when there is an MTC device initially attaching, check the MTC device group information of the MTC device according to MTC device information, and when the MTC device belongs to the created MTC device group, after the MTC device completes the attachment, send the MTC device group information of the MTC device group to the MTC device in a secure way.

Optionally, the sending unit sends the MTC device group information of the MTC device group, to which the MTC device belongs, to the MTC device in the following way:

after the group creating unit creates the MTC device group, the sending unit sends the MTC device group information to all MTC devices contained in the MTC device group.

Optionally, the network entity further includes a key unit, wherein:

the key unit is configured to generate an encryption key and an integrity protection key according to the MTC device group key information; and

the MTC device group information includes MTC device group identification information, MTC device group key information, encryption key information and integrity protection key.

Optionally, a machine type communication (MTC) device includes a receiving unit and a communication unit, herein:

the receiving unit is configured to receive MTC device group information corresponding to an MTC device group, to which the MTC device belongs, from a network entity, herein the MTC device group information includes MTC device group identification information and MTC device group key information; and

the communication unit is configured to use the MTC device group key information as a shared key with different MTC devices in the MTC device group, to which the MTC device belongs, for protecting secure communication with different MTC devices in the MTC device group to which the MTC device belongs.

Optionally, the communication unit is further configured to generate an encryption key and an integrity protection key for protecting secure data transmission between MTC devices according to the MTC device group key information; and perform secure MTC data transmission with different MTC devices in the MTC device group, to which the MTC device belongs, through the encryption key and the integrity protection key.

Optionally, the MTC device group information further includes an encryption key and an integrity protection key; the communication unit is configured to perform secure MTC data transmission with different MTC devices in the MTC device group, to which the MTC device belongs, through the encryption key and the integrity protection key.

To sum up, the embodiments of the present invention solve the problem of how to guarantee secure communication between an MTC device and another MTC device. When the MTC device directly communicate with any other MTC device, a secure transmission channel for data communication between MTC devices can be established according to the MTC device group information.

### BRIEF DESCRIPTION OF THE DRAWINGS

FIG. 1 is a schematic diagram of direct communication between MTC devices in related arts;

FIG. 2 is a schematic diagram of communication between MTC devices through an MTC server in related arts;

FIG. 3 is a schematic diagram of a system based on direction communication between MTC devices according to the embodiment of the present invention;

FIG. 4 is a schematic diagram of a system based on direction communication between MTC devices according to the embodiment of the present invention;

FIG. 5 is a schematic diagram of MTC device group information distribution based on direction communication between MTC devices according to the embodiment of the present invention;

FIG. 6 is a schematic diagram of MTC device group information distribution based on direction communication between MTC devices according to the embodiment of the present invention;

FIG. 7 is a schematic diagram of MTC device group information distribution based on direction communication between MTC devices according to the embodiment of the present invention;

FIG. 8 is a schematic diagram of MTC device group information distribution based on direction communication between MTC devices according to the embodiment of the present invention;

FIG. 9 is a structural schematic diagram of a network entity based on secure communication between MTC devices according to the embodiment of the present invention;

FIG. 10 is a structural schematic diagram of an MTC device based on secure communication between MTC devices according to the embodiment of the present invention.

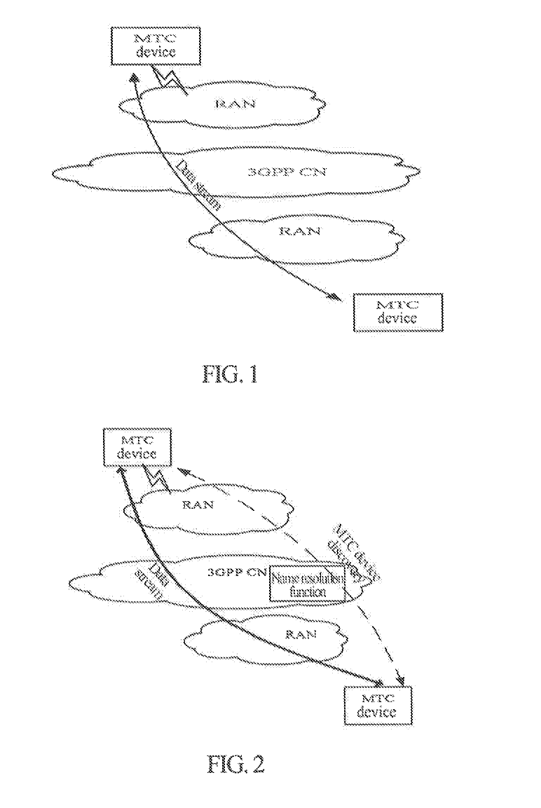

### PREFERRED EMBODIMENTS OF THE INVENTION

In the embodiments of the present invention, MTC devices can be maintained and managed through a network entity. For example, MTC devices can be maintained and managed through an eNB, or MME or SGSN, or MTC devices can be maintained and managed through an HSS. For the situation that the MTC devices are maintained and managed through the HSS, when different MTC devices need to directly communicate, an MTC device group can be created at the HSS. The MTC device group consisting of the MTC devices which need to directly communicate can be created by an MTC subscriber, can also be initially created by an MTC device which initiates direct communication between the MTC devices, and can also be created by an entity which manages the communication between the MTC devices, such as an eNB, MME or SGSN. For example, the MTC subscriber can create at the HSS an MTC device group which needs to directly communicate. Or for example, an MTC device which initiates direct communication between the MTC devices sends information related to the direct communication between the MTC devices to a mobile communication network, and a related entity of the mobile communication network, such as ENB, MME or HSS etc, creates an MTC device group according to the information related to the direct communication. Or for example, an entity such as eNB, MME or SGSN etc which manages the communication between the MTC devices establishes direct communication between the MTC devices according to an actual situation of communication, and creates an MTC device group which needs to directly communicate.

Information of the MTC device and information of the MTC device group to which the MTC device belongs are saved in a mobile communication network entity, such as saving at an eNB, MME, SGSN or HSS etc. The MTC device group information includes MTC device group identification information and MTC device group key information. All MTC devices in the MTC device group have the same MTC device group information. When an MTC device belongs to a created MTC device group, the information of the MTC device group to which the MTC device belongs also needs to be saved on the MTC device, e.g., the information of the MTC device group to which the MTC device belongs is saved on the UICC of the MTC device. Specifically, for the situation that the MTC device group is maintained and managed by the HSS, maybe, after the MTC subscriber creates the MTC device group at the HSS, when an MTC device initially attaches to the network, the HSS checks the MTC device group information to which the MTC device belongs according to the MTC device information such as IMSI information, and when the MTC device belongs to a created MTC device group, after the MTC device completes an attachment process, the network sends the information of the MTC device group, to which the MTC device belongs, to the MTC device in a secure way for the purpose of saving, e.g., saving on the UICC of the MTC device. For the situation that the MTC device group is maintained and managed by the eNB, MME or SGSN, after the eNB, or MME or SGSN creates the MTC device group, the eNB, or MME or SGSN needs to send the MTC device group information securely to all MTC devices in the MTC device group.

In the embodiments of the present invention, the MTC device information saved by the mobile communication network entity such as eNB, MME, SGSN or HSS etc can include MTC device information, such as IMSI and IMEI, and can also include machine type communication capability information.

In order to solve the technical problem of how to guarantee the secure data transmission between MTC devices and other MTC devices, a method for realizing secure communication between MTC devices provided by the present invention includes:

I. For the situation that the MTC device group is maintained and managed by the HSS:

An MTC device sends attachment request information to a network, herein the attachment request information includes MTC device information, such as IMSI;

a network side MME sends authentication data request information to an HSS;

the HSS firstly checks the MTC device information and the MTC device group information according to the saved MTC device information and MTC device group information, and when it is determined that the MTC device belongs to the MTC device group, the HSS generates authentication response data according to the MTC device information.

The HSS sends the authentication response data to the MME.

The MME and the MTC device complete mutual authentication.

The MME sends the MTC device group information to the MTC device.

The MTC device saves, maintains and manages the MTC device group information. An MTC device group key is used as a shared key between different MTC devices in the MTC device group and is used for protecting secure communication between different MTC devices in the MTC device group.

During communication between the MTC devices, next-level keys such as an encryption key and an integrity protection key for protecting secure data transmission between the MTC devices can be generated through the MTC device group key according to the needs of the system.

The MTC device and another MTC device perform secure MTC data transmission through the generated shared keys such as the encryption key and the integrity protection key.

II. For the situation that the MTC device group is maintained and managed by the mobile communication network entity such as eNB, MME or SGSN:

An MTC device attaches to a mobile communication network.

A secure mobile communication connection is established between a mobile communication network entity and the MTC device.

The MTC device sends communication request information to the network, herein the communication request information includes device information of the MTC device, such as IMSI or IMEI etc, or simultaneously includes IMSI and IMEI; and further includes device information of another MTC device with which the MTC device needs to communicate, such as IMSI or IMEI etc, or simultaneously includes IMSI and IMEI.

The mobile communication network entity such as eNB, MME or SGSN creates an MTC device group according to the communication request information sent by the MTC device to the network, and saves MTC device group information, herein the MTC device group information includes MTC device group identification information and MTC device group key information.

The mobile communication network entity such as eNB, MME or SGSN sends the MTC device group information to the MTC device.

The MTC device saves, maintains and manages the MTC device group information. An MTC device group key is used as a shared key between different MTC devices in the MTC device group and is used for protecting secure communication between different MTC devices in the MTC device group.

During communication between the MTC devices, next-level keys such as an encryption key and an integrity protection key for protecting secure data transmission between the MTC devices can be generated through the MTC device group key according to the needs of the system.

The MTC device and another MTC device perform secure MTC data transmission through the generated shared keys such as the encryption key and the integrity protection key.

In the embodiments of the present invention, after one MTC device and a plurality of other MTC devices in the MTC device group establish secure MTC data transmission, the previously created MTC device group information can be directly used to establish a secure connection for direct communication between the other different MTC devices.

The embodiment of the present invention further provides a network entity, including a group creating unit and a sending unit, herein:

the group creating unit is configured to create an MTC device group for a directly-communicating MTC device, and save MTC device group information corresponding to the MTC device group and MTC device information of an MTC device contained in the MTC device group, herein the MTC device group information includes MTC device group identification information and MTC device group key information;

the sending unit is configured to send the MTC device group information of the MTC device group, to which the MTC device belongs, to the MTC device.

The group creating unit is set at a Home Subscriber Server (HSS), and the group creating unit creates an MTC device group for a directly-communicating MTC device in any one of the following ways:

(1) the group creating unit creates the MTC device group for an MTC device which needs to directly communicate according to a creating request of an MTC subscriber;

(2) the group creating unit creates the MTC device group for an MTC device which needs to directly communicate under a situation that a direct communication request initiated by the MTC device is received;

(3) the group creating unit creates the MTC device group for an MTC device which needs to directly communicate according to a request of an entity which manages communication between MTC devices.

The group creating unit is set at an entity which manages communication between MTC devices, and the group creating unit creates an MTC device group for a directly-communicating MTC devices in any one of the following ways:

(1) the group creating unit creates the MTC device group for an MTC device which needs to directly communicate under a situation that the entity which manages communication between MTC devices receives the direct communication request initiated by the MTC device;

(2) the group creating unit creates the MTC device group for an MTC device which needs to directly communicate when the entity which manages communication between MTC devices establishes a direct communication between MTC devices.

The entity which manages communication between MTC devices is a base station, a Mobility Management Entity MME or a Service GPRS Supporting Node SGSN.

The sending unit sends the MTC device group information of the MTC device group, to which the MTC device belongs, to the MTC device in the following way:

when the group creating unit creates the MTC device group for the MTC device which needs to directly communicate under the situation that the group creating unit receives the direct communication request initiated by the MTC device, after the group creating unit creates the MTC device group, the sending unit sends the MTC device group information to the MTC device which initiates the direct communication request.

The sending unit is further configured to, when there is an MTC device initially attaching, check the MTC device group information of the MTC device according to the MTC device information, and when the MTC device belongs to the created MTC device group, after the MTC device completes the attachment, send the MTC device group information of the MTC device to the MTC device in a secure way.

The sending unit sends the MTC device group information of the MTC device group, to which the MTC device belongs, to the MTC device in the following way:

after the group creating unit creates the MTC device group, the sending unit sends the MTC device group information to all MTC devices contained in the MTC device group.

The network entity further includes a key unit, herein:

the key unit is configured to generate an encryption key and an integrity protection key according to the MTC device group key information;

the MTC device group information includes MTC device group identification information, MTC device group key information, encryption key information and integrity protection key information.

The embodiment of the present invention further provides a machine type communication device, including a receiving unit and a communication unit, herein:

the receiving unit is configured to receive MTC device group information corresponding to an MTC device group, to which the MTC device belongs, from a network entity, herein the MTC device group information includes MTC device group identification information and MTC device group key information;

the communication unit is configured to use the MTC device group key information as a shared key with different MTC devices in the MTC device group, to which the MTC device belongs, for protecting secure communication with different MTC devices in the MTC device group to which the MTC device belongs.

The communication unit is further configured to generate an encryption key and an integrity protection key for protecting secure data transmission between MTC devices according to the MTC device group key information; and perform secure MTC data transmission with different MTC devices in the MTC device group, to which the MTC device belongs, through the encryption key and the integrity protection key.

The MTC device group information further includes an encryption key and an integrity protection key;

the communication unit is configured to perform secure MTC data transmission with different MTC devices in the MTC device group, to which the MTC device belongs, through the encryption key and the integrity protection key.

The present invention will be described below in detail by referring to the drawings in combination with the embodiments. It needs to be stated that the embodiments and the features of the embodiments in the present invention can be combined with one another under the situation of no conflict.

As shown in FIG. 3, a system based on direct communication between MTC devices according to the embodiment of the present invention includes different MTC devices which need to directly communicate, wherein the MTC devices are used for storing MTC device group information; an MME used for an NAS signaling processing; and an HSS for managing and maintaining the MTC device information and the MTC device group information.

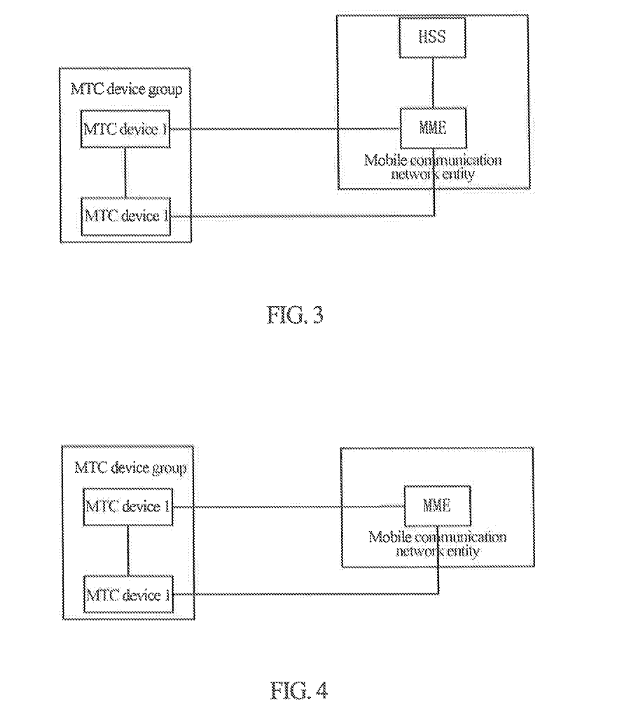

As shown in FIG. 4, a system based on direct communication between MTC devices according to the embodiment of the present invention includes different MTC devices which need to directly communicate, wherein the MTC devices are used for storing MTC device group information; an MME used for an NAS signaling processing and managing and maintaining the MTC device and MTC device group information.

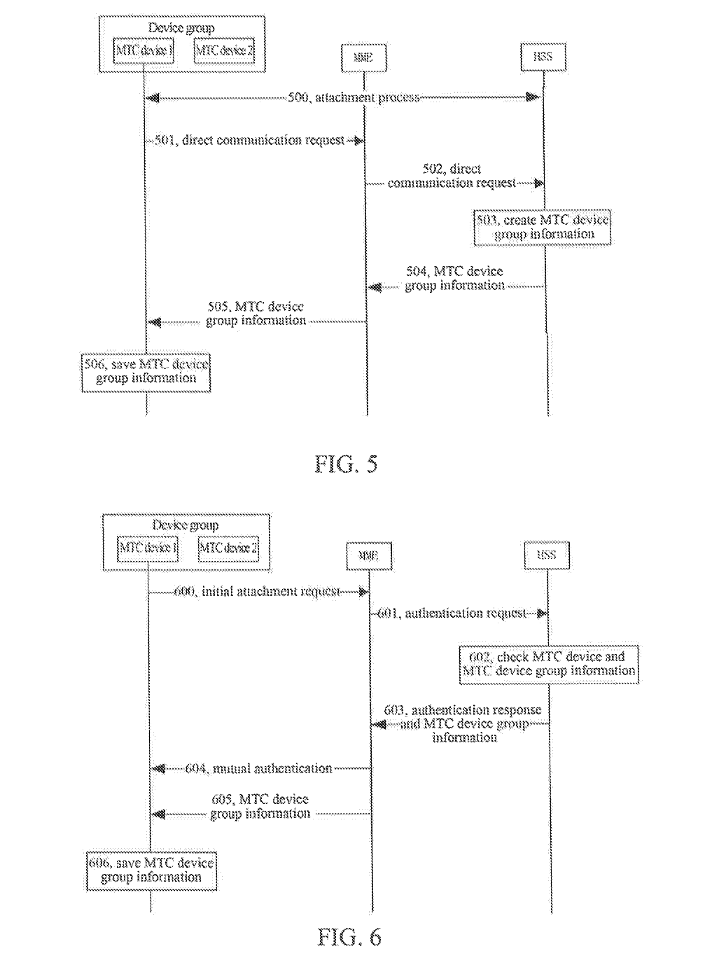

For the situation that the MTC device information and the MTC device group information are maintained and managed by the HSS, with respect to an MTC device which initiates direct communication, when the MTC device initially attaches, an MTC device group information distribution process, as shown in FIG. 5, includes the following steps that:

In Step 500, an MTC device completes an attachment process.

In Step 501, the MTC device sends MTC device direct communication request information to a mobile communication network, herein the direct communication request information includes information of the MTC device which needs to directly communicate, such as IMSI or IMEI etc, or simultaneously includes IMSI and IMEI; and further includes device information of another MTC device with which the MTC device needs to communicate, such as IMSI or IMEI etc, or simultaneously includes IMSI and IMEI.

In Step 502, an MME sends the direct communication request information to an HSS.

In Step 503, the HSS creates MTC device group information according to the direct communication request information.

The MTC device group information includes MTC device group identification information and MTC device group key information, herein the MTC device group key information is used for protecting the security of communication between the MTC devices.

When the MTC device group information is created, the HSS can generate an encryption key and an integrity protection key on the basis of the MTC device group key according to the needs of the system. Under this situation, the MTC device group information includes MTC device group identification information, MTC group key information, encryption key information and integrity protection key information. The encryption key and the integrity protection key are used for protecting the security of communication between the MTC devices.

In Step 504, the HSS sends the MTC device group information to the MME.

In Step 505, the MME sends the MTC device group information to the MTC device through a secure connection between the MME and the MTC device.

In Step 506, the MTC device saves the MTC device group information.

For the situation that the MTC device information and the MTC device group information are maintained and managed by the HSS, with respect to an MTC device which participates in direct communication, when the MTC device initially attaches, an MTC device group information distribution process, as shown in FIG. 6, includes the following steps that:

In Step 600, an MTC device sends attachment request information to a network, herein the attachment request information includes MTC device information such as IMSI or IMEI etc, or simultaneously includes IMSI and IMEI;

In Step 601, an MME sends authentication data request information to an HSS.

In Step 602, the HSS checks MTC device group information of an MTC device group to which the MTC device belongs according to the MTC device information.

In Step 603, the HSS sends both the MTC device information and authentication data to the MME.

In Step 604, the MME and the MTC device complete mutual authentication according to the authentication data.

In Step 605, the MME sends the MTC device group information to the MTC device through a secure connection between the MME and the MTC device.

In Step 606, the MTC device saves the MTC device group information.

For the situation that the MTC device information and the MTC device group information are maintained and managed by the MME in the mobile communication network, when an MTC device needs to communicate with another MTC device, with respect to the MTC device which initiates direct communication, an MTC device group information distribution process, as shown in FIG. 7, includes the following steps that:

In Step 700, an MTC device sends attachment request information to a network, and completes a network attachment process, herein the attachment request information includes MTC device information such as IMSI.

In Step 701, the MTC device sends communication request information to the network.

The communication request information includes device information of the MTC device, such as IMSI or IMEI etc, or simultaneously includes IMSI and IMEI; and further includes device information of another MTC device with which the MTC device needs to communicate, such as IMSI or IMEI etc, or simultaneously includes IMSI and IMEI.

In Step 702, the MME creates an MTC device group according to the communication request information sent by the MTC device to the network, and saves MTC device group information, herein the MTC device group information includes MTC device group identification information and MTC device group key information.

The MTC device group information includes MTC device group identification information and MTC device group key information, herein the MTC device group key information is used for protecting the security of communication between the MTC devices.

When the MTC device group information is created, the MME can generate an encryption key and an integrity protection key on the basis of the MTC device group key according to the needs of the system. Under this situation, the MTC device group information includes MTC device group identification information, MTC group key information, encryption key information and integrity protection key information. The encryption key and the integrity protection key are used for protecting the security of communication between the MTC devices.

In Step 703, the MME sends the MTC device group information to the MTC device through a secure connection between the MME and the MTC device.

In Step 704, the MTC device saves the MTC device group information.

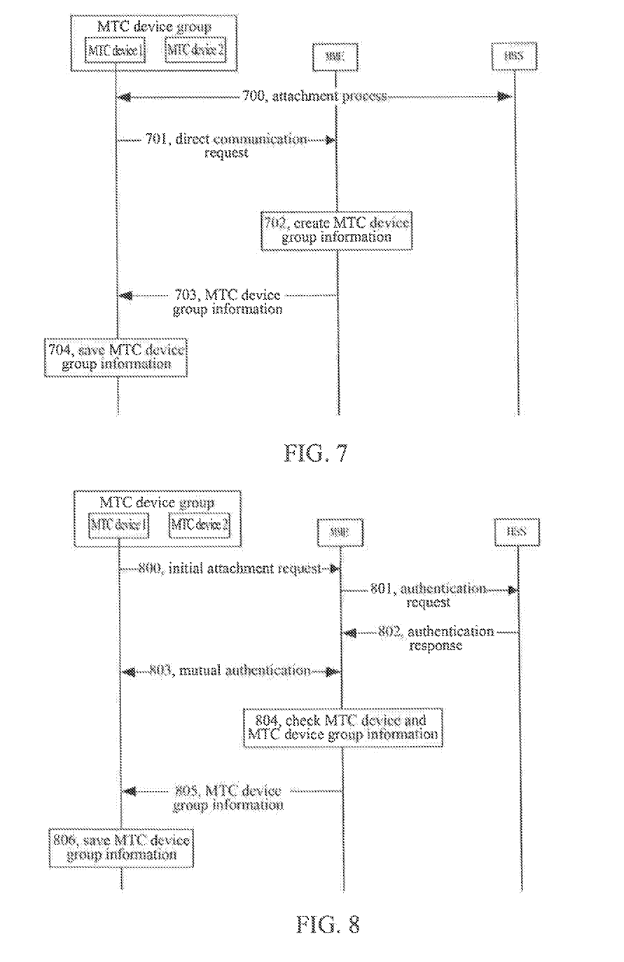

For the situation that the MTC device information and the MTC device group information are maintained and managed by the MME in the mobile communication network, when an MTC device needs to communicate with another MTC device, with respect to the MTC device which participates in direct communication, an MTC device group information distribution process, as shown in FIG. 8, includes the following steps that:

In Step 800, an MTC device sends attachment request information to a network, herein the attachment request information includes MTC device information such as IMSI or IMEI or simultaneously includes IMSI and IMEI.

In Step 801, an MME sends authentication data request information to an MME.

In Step 802, the HSS sends authentication data to the MME.

In Step 803, the MME and the MTC device complete mutual authentication according to the authentication data.

In Step 804, the MME checks MTC device group information of an MTC device group to which the MTC device belongs according to the MTC device information.

In Step 805, the MME sends the MTC device group information to the MTC device through a secure connection between the MME and the MTC device.

In Step 806, the MTC device saves the MTC device group information.

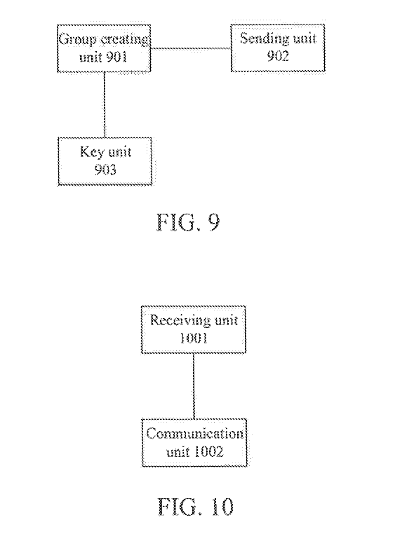

As shown in FIG. 9, the embodiment of the present invention further provides a network entity, including a group creating unit 901 and a sending unit 902, herein:

the group creating unit 901 is configured to create an MTC device group for a directly-communicating MTC device, and save MTC device group information corresponding to the MTC device group and MTC device information of an MTC device contained in the MTC device group, herein the MTC device group information includes MTC device group identification information and MTC device group key information;

the sending unit 902 is configured to send the MTC device group information of the MTC device group, to which the MTC device belongs, to the MTC device.

The group creating unit 901 is set at a Home Subscriber Server (HSS), and the group creating unit creates an MTC device group for a directly-communicating MTC devices under any one of the following situations, including:

(1) the group creating unit creates the MTC device group for an MTC device which needs to directly communicate according to a creating request of an MTC subscriber;

(2) the group creating unit creates the MTC device group for an MTC device which needs to directly communicate under a situation that a direct communication request initiated by the MTC device is received; and

(3) the group creating unit creates the MTC device group for an MTC device which needs to directly communicate according to a request of an entity which manages communication between MTC devices.

The group creating unit 901 is set at an entity which manages communication between MTC devices, and the group creating unit creates an MTC device group for a directly-communicating MTC devices under any one of the following situations, including:

(1) the group creating unit creates the MTC device group for an MTC device which needs to directly communicate under a situation that the entity which manages communication between MTC devices receives the direct communication request initiated by the MTC device; and

(2) the group creating unit creates the MTC device group for an MTC device which needs to directly communicate when the entity which manages communication between MTC devices establishes a direct communication between MTC devices.

The entity which manages communication between MTC devices is a base station, a Mobility Management Entity (MME) or a Service GPRS Supporting Node (SGSN).

The sending unit sends the MTC device group information of the MTC device group, to which the MTC device belongs, to the MTC device, including:

when the group creating unit 901 creates the MTC device group for the MTC device which needs to directly communicate under the situation that the group creating unit 901 receives the direct communication request initiated by the MTC device, after the group creating unit creates the MTC device group, the sending unit 902 sends the MTC device group information to the MTC device which initiates the direct communication request.

The sending unit 902 is further configured to, when there is an MTC device initially attaching, check the MTC device group information of the MTC device according to MTC device information, and when the MTC device belongs to the created MTC device group, after the MTC device completes the attachment, send the MTC device group information of the MTC device to the MTC device in a secure way.

The sending unit 902 sends the MTC device group information of the MTC device group, to which the MTC device belongs, to the MTC device, including:

after the group creating unit creates the MTC device group, the sending unit 902 sends the MTC device group information to all MTC devices contained in the MTC device group.

The network entity further includes a key unit 903, herein:

the key unit 903 is configured to generate an encryption key and an integrity protection key according to the MTC device group key information; and

the MTC device group information includes MTC device group identification information, MTC device group key information, encryption key information and integrity protection key information.

As shown in FIG. 10, the embodiment of the present invention further provides a machine type communication MTC device, including a receiving unit 1001 and a communication unit 1002, herein:

the receiving unit 1001 is configured to receive MTC device group information corresponding to an MTC device group, to which the MTC device belongs, from a network entity, herein the MTC device group information includes MTC device group identification information and MTC device group key information;

the communication unit 1002 is configured to use the MTC device group key information as a shared key with different MTC devices in the MTC device group, to which the MTC device belongs, for protecting secure communication with different MTC devices in the MTC device group to which the MTC device belongs.

The communication unit 1002 is further configured to generate an encryption key and an integrity protection key for protecting secure data transmission between MTC devices according to the MTC device group key information; and perform secure MTC data transmission with different MTC devices in the MTC device group, to which the MTC device belongs, through the encryption key and the integrity protection key.

The MTC device group information further includes an encryption key and an integrity protection key; and

the communication unit 1002 is configured to perform secure MTC data transmission with different MTC devices in the MTC device group, to which the MTC device belongs, through the encryption key and the integrity protection key.

One ordinary skilled in the art can understand that all or partial steps in the above-mentioned methods can be completed by relevant hardware instructed by a program, and the program can be stored in a computer readable storage medium such as a read only memory, a magnetic disk or a compact disk etc. Optionally, all or partial steps of the above-mentioned embodiments can also be implemented by using one or more integrated circuits. Correspondingly, each module/unit in the above-mentioned embodiments can be implemented by means of hardware, and can also be implemented by means of a software function module. The present invention is not limited to combinations of hardware and software in any specific form.

The embodiments described above are just preferred embodiments of the present invention and are not used for limiting the present invention. For one skilled in the art, the present invention may have various modifications and variations. However, all modifications, equivalent replacements and improvements made within the essence and the principle of the present invention shall also be included in the protection range of the present invention.

### INDUSTRIAL APPLICABILITY

The embodiments of the present invention solve the problem of how to guarantee secure communication between an MTC device and another MTC device. When the MTC device directly communicate with any other MTC device, a secure transmission channel for data communication between MTC devices can be established according to the MTC device group information.

1. A method for realizing secure communication between machine type communication (MTC) devices, comprising:
creating, by a network entity, an MTC device group for a directly-communicating MTC device, and saving MTC device group information corresponding to the MTC device group and MTC device information of an MTC device contained in the MTC device group, wherein the MTC device group information comprises MTC device group identification information and MTC device group key information; and
sending, by the network entity, the MTC device group information of the MTC device group, to which the MTC device belongs, to the MTC device.

2. The method according to claim 1, wherein:
the network entity is a Home Subscriber Serve (HSS), and creating, by the HSS, an MTC device group for a directly-communicating MTC device under any one of the following situations comprises:
creating the MTC device group for an MTC device which needs to directly communicate according to a creating request of an MTC subscriber;
creating the MTC device group for an MTC device which needs to directly communicate under a situation that a direct communication request initiated by the MTC device is received; and
creating the MTC device group for an MTC device which needs to directly communicate according to a request of an entity which manages communication between MTC devices.

3. The method according to claim 1, wherein:
the network entity is an entity which manages communication between MTC devices, and creating, by the entity which manages communication between MTC devices, an MTC device group for a directly-communicating MTC device under any one of the following situations comprises:
creating, by the entity which manages communication between MTC devices, the MTC device group for an MTC device which needs to directly communicate under a situation that the entity which manages communication between MTC devices receives the direct communication request initiated by the MTC device; and
creating, by the entity which manages communication between MTC devices, the MTC device group for an MTC device which needs to directly communicate when the entity which manages communication between MTC devices establishes a direct communication between MTC devices.

4. The method according to claim 3, wherein the entity which manages communication between MTC devices is a base station, a Mobility Management Entity (MME) or a Service GPRS Supporting Node (SGSN).

5. The method according to claim 1, wherein sending, by the network entity, the MTC device group information of the MTC device group, to which the MTC device belongs, to the MTC device comprises:
when the network entity creates the MTC device group for the MTC device which needs to directly communicate under the situation that the network entity receives the direct communication request initiated by the MTC device, after creating the MTC device group, sending the MTC device group information to the MTC device which initiates the direct communication request.

6. The method according to claim 5, wherein sending, by the network entity, the MTC device group information of the MTC device group, to which the MTC device belongs, to the MTC device further comprises:
when there is an MTC device initially attaching, checking, by the network entity, the MTC device group information of the MTC device according to MTC device information, and when the MTC device belongs to the created MTC device group, after the MTC device completes the attachment, sending the MTC device group information of the MTC device to the MTC device in a secure way.

7. The method according to claim 1, wherein sending, by the network entity, the MTC device group information of the MTC device group, to which the MTC device belongs, to the MTC device comprises:
after the network entity creates the MTC device group, sending, by the network entity, the MTC device group information to all MTC devices contained in the MTC device group.

8. The method according to claim 1, further comprising:
generating, by the network entity, an encryption key and an integrity protection key according to the MTC device group key information; and
wherein the MTC device group information comprise MTC device group identification information, MTC device group key information, encryption key information and integrity protection key.

9. A method for realizing secure communication between machine type communication (MTC) devices, comprising:
receiving, by an MTC device, MTC device group information corresponding to an MTC device group, to which the MTC device belongs, from a network entity, wherein the MTC device group information comprises MTC device group identification information and MTC device group key information; and
using, by the MTC device, the MTC device group key information as a shared key with different MTC devices in the MTC device group, to which the MTC device belongs, for protecting secure communication with different MTC devices in the MTC device group to which the MTC device belongs.

10. The method according to claim 9, further comprising:
generating, by the MTC device, an encryption key and an integrity protection key for protecting secure data transmission between MTC devices according to the MTC device group key information; and
performing, by the MTC device, secure MTC data transmission with different MTC devices in the MTC device group, to which the MTC device belongs, through the encryption key and the integrity protection key, or,
further comprising;
the MTC device group information further comprising an encryption key and an integrity protection key; and
performing, by the MTC device, secure MTC data transmission with different MTC devices in the MTC device group, to which the MTC device belongs, through the encryption key and the integrity protection key.

11. (canceled)

12. A network entity, comprising a group creating unit and a sending unit, wherein:
the group creating unit is configured to create an MTC device group for a directly-communicating MTC device, and save MTC device group information corresponding to the MTC device group and MTC device information of an MTC device contained in the MTC device group, wherein the MTC device group information comprises MTC device group identification information and MTC device group key information; and
the sending unit is configured to send the MTC device group information of the MTC device group, to which the MTC device belongs, to the MTC device.

13. The network entity according to claim 12, wherein:
the group creating unit is set at a Home Subscriber Server (HSS), and the group creating unit creates an MTC device group for a directly-communicating MTC device in any one of the following ways:
creating the MTC device group for an MTC device which needs to directly communicate according to a creating request of an MTC subscriber;
creating the MTC device group for an MTC device which needs to directly communicate under a situation that a direct communication request initiated by the MTC device is received; and
creating the MTC device group for an MTC device which needs to directly communicate according to a request of an entity which manages communication between MTC devices.

14. The network entity according to claim 12, wherein:
the group creating unit is set at an entity which manages communication between MTC devices, and the group creating unit creates an MTC device group for a directly-communicating MTC device in any one of the following ways:
creating the MTC device group for an MTC device which needs to directly communicate under a situation that the entity which manages communication between MTC devices receives the direct communication request initiated by the MTC device; and
creating the MTC device group for MTC device which needs to directly communicate when the entity which manages communication between MTC devices establishes a direct communication between MTC devices.

15. The network entity according to claim 14, wherein the entity which manages communication between MTC devices is a base station, a Mobility Management Entity (MME) or a Service GPRS Supporting Node (SGSN).

16. The network entity according to claim 12, wherein the sending unit sends the MTC device group information of the MTC device group, to which the MTC device belongs, to the MTC device in the following way:
when the group creating unit creates the MTC device group for the MTC device which needs to directly communicate under the situation that the group creating unit receives the direct communication request initiated by the MTC device, after the group creating unit creates the MTC device group, the sending unit sends the MTC device group information to the MTC device which initiates the direct communication request.

17. The network entity according claim 16, wherein:
the sending unit is further configured to, when there is an MTC device initially attaching, check the MTC device group information of the MTC device according to MTC device information, and when the MTC device belongs to the created MTC device group, after the MTC device completes the attachment, send the MTC device group information of the MTC device to the MTC device in a secure way.

18. The network entity according to claims 12, wherein the sending unit sends the MTC device group information of the MTC device group, to which the MTC device belongs, to the MTC device in the following way:
after the group creating unit creates the MTC device group, the sending unit sends the MTC device group information to all MTC devices contained in the MTC device group.

19. The network entity according to claims 12, further comprising a key unit, wherein:
the key unit is configured to generate an encryption key and an integrity protection key according to the MTC device group key information; and
the MTC device up information comprises MTC device group identification information, MTC device group key information, cryption key information and integrity protection key.

20. A Machine Type Communication (MTC) device, comprising a receiving unit and a communication unit, wherein:
the receiving unit is configured to receive MTC device group information corresponding to an MTC device group, to which the MTC device belongs, from a network entity, wherein the MTC device group information comprises MTC device group identification information and MTC device group key information; and
the communication unit is configured to use the MTC device group key information as a shared key with different MTC devices in the MTC device group, to which the MTC device belongs, for protecting secure communication with different MTC devices in the MTC device group to which the MTC device belongs.

21. The machine type communication device according to claim 20, wherein:
the communication unit is further configured to generate an encryption key and an integrity protection key for protecting secure data transmission between MTC devices according to the MTC device group key information; and perform secure MTC data transmission with different MTC devices in the MTC device group, to which the MTC device belongs, through the encryption key and the integrity protection key,
or,
wherein:
the MTC device group information further comprises the encryption key and the integrity protection key; and
the communication unit is configured to perform secure MTC data transmission with different MTC devices in the MTC device group, to which the MTC device belongs, throught the encryption key and the integrity protection key.

22. (canceled)
